(19) United States
(12) Patent Application Publication
(10) Pub. No.: US 2017/0186318 A1
(43) Pub. Date: Jun. 29, 2017

(54) DRIVING SUPPORT SYSTEM, DRIVING SUPPORT METHOD AND PROGRAM

(71) Applicant: Mitsubishi Electric Corporation, Tokyo (JP)

(72) Inventors: Shu MURAYAMA, Tokyo (JP); Michinori YOSHIDA, Tokyo (JP); Kenichi KOBIKI, Tokyo (JP); Junya UJIIE, Tokyo (JP)

(73) Assignee: Mitsubishi Electric Corporation, Tokyo (JP)

(21) Appl. No.: 15/320,362

(22) PCT Filed: Jul. 22, 2014
(86) PCT No.: PCT/JP2014/003846

§ 371 Date: Dec. 20, 2016

(51) Int. Cl. G08G 1/16; B60Q 1/52

(52) U.S. Cl. CPC G08G 1/16; B60Q 1/525; B60W 2550/10

(57) ABSTRACT

Conventional driving support systems have a problem that the driver of a user's vehicle is still at a hazard because the conventional driving support systems cannot make another vehicle irradiate, with its visible light, an obstacle existing at a position which the user's vehicle cannot detect with its on-vehicle radar, etc. According to the present invention, a determination unit 104 determines, on the basis of position information of a first moving object and position information of an obstacle, whether or not the first moving object detects the obstacle, and a controller 105 informs the first moving object of the existence of the obstacle when the determination unit 104 determines that the first moving object does not detect the obstacle.

### TECHNICAL FIELD

The present invention relates to a driving support system, a driving support method and a program which help drivers, etc. perceive the existence of an obstacle.

### BACKGROUND ART

A conventional driving support technology is known which detects an obstacle including a pedestrian using an on-vehicle radar device such as a millimeter-wave radar or a laser radar, and informs the driver of a hazard by means such as irradiating the detected obstacle with visible light.

In a driving support system described in Patent Document 1, when an obstacle exists at a position too distant from a user's vehicle to irradiate with visible light, the driving support device of the user's vehicle transmits a warning request signal, and then another vehicle receiving the warning request activates its driving support device to control its light to irradiate the obstacle so that the driver of the user's vehicle will perceive the existence of the obstacle.

### PRIOR ART DOCUMENT

### Patent Document

Patent Document 1

Japanese Patent Laid-Open Publication No. 2010-277123

### SUMMARY OF THE INVENTION

### The Problem to be Solved by the Invention

The conventional driving support system, however, has a problem that the driver of a user's vehicle is still at a hazard because an obstacle existing at a position which the user's vehicle cannot detect with its on-vehicle radar, etc. cannot be irradiated by another vehicle with visible light.

The present invention is made to solve the problem described above and to provide a driving support system which helps a driver perceive the existence of an obstacle to avoid a hazard even when the obstacle cannot be detected by the on-vehicle radar or the like.

### The Means for Solving the Problem

A driving support system according to the present invention includes a determination unit to determine, on the basis of position information of a first moving object and position information of an obstacle, whether or not the first moving object detects the obstacle, and a controller to inform the first moving object of the existence of the obstacle when the determination unit determines that the first moving object does not detect the obstacle.

A driving support method according to the present invention includes a step of determining, on the basis of position information of a first moving object and position information of the an obstacle, whether or not the first moving object detects the obstacle and a step of warning the first moving object of the existence of the obstacle when the determination unit determines that the first moving object does not detect the obstacle.

A computer program according to the present invention is to execute a process to determine, on the basis of position information of a first moving object and position information of an obstacle, whether or not the first moving object detects the obstacle, and a process to inform the first moving object of the existence of the obstacle when a determination unit determines that the first moving object does not detect the obstacle.

### Effects of the Invention

According to a driving support system, a driving support method and a program which relate to the present invention, the driver of a first moving object can avoid a hazard because the first moving object which does not detect an obstacle is to be informed of the existence of the obstacle.

### BRIEF DESCRIPTION OF DRAWINGS

FIG. 1 is a drawing which shows a positional relation between a user's vehicle A and another vehicle B according to Embodiment 1;

FIG. 2 is a diagram which shows an example configuration of a driving support device 100 according to Embodiment 1;

FIG. 3 is a diagram which shows an example of the hardware configuration of the driving support device 100 according to Embodiment 1;

FIG. 4 is a flowchart which shows an example of obstacle warning processing according to Embodiment 1;

FIG. 5 is a flowchart which shows an example of algorithm of determination processing according to Embodiment 1;

FIG. 6 is a drawing which shows an example of operation of the other vehicle B, according to Embodiment 1, to inform the user's vehicle A of the existence of an obstacle;

FIG. 7 is a drawing which shows another example of operation of the other vehicle B, according to Embodiment 1, to inform the user's vehicle A of the existence of an obstacle;

FIG. 8 is a diagram which shows an example configuration of a server according to Embodiment 2;

FIG. 9 is a drawing which shows information exchange between devices according to Embodiment 2;

FIG. 10 is a flowchart which shows an example of operations of obstacle warning processing according to Embodiment 2;

FIG. 11 is a drawing which shows an example of operation of the server 200 according to Embodiment 2 to inform the user's vehicle A of the existence of an obstacle;

FIG. 12 is a drawing which shows another example of operation of the server 200 according to Embodiment 2 to inform the user's vehicle A of the existence of an obstacle;

FIG. 13 is a diagram which shows a configuration example of a server according to Embodiment 3;

FIG. 14 is a table which lists examples on detection performance information according to Embodiment 3; and

FIG. 15 is a flowchart which shows an operation example of obstacle warning according to Embodiment 3.

### EMBODIMENTS FOR CARRYING OUT THE INVENTION

### Embodiment 1

Embodiment 1 of the present invention will be explained below using the drawings.

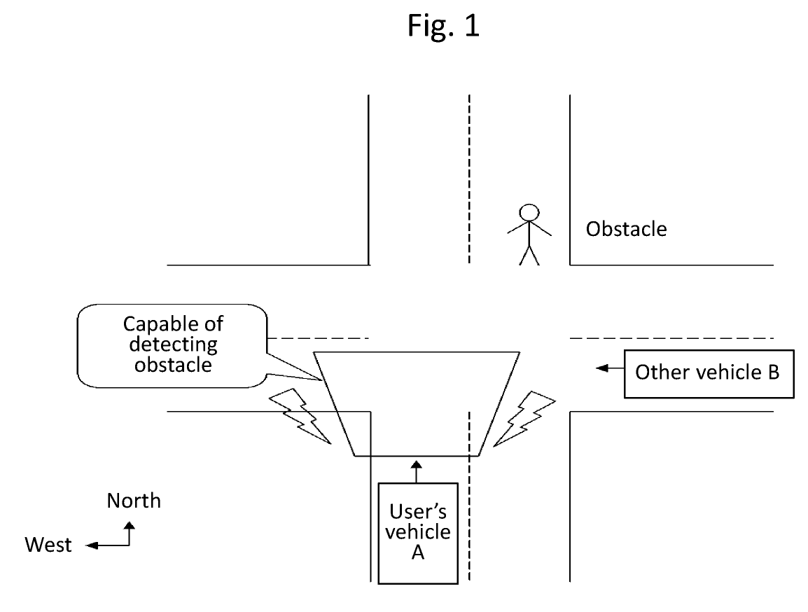

FIG. 1 is a drawing which shows a positional relation between a user's vehicle A and another vehicle B according to Embodiment 1. The user's vehicle A is a vehicle traveling from south to north on a road. The other vehicle B is a vehicle traveling from east to west. Each of the user's vehicle A and the other vehicle B is mounted with a driving support device to be explained later. Here, explanation is made using vehicles as examples. However, the examples are not limited to the vehicles, and a driving support device may be a mobile terminal or the like carried by people. In the following explanations, a user's vehicle A may be referred to as a first moving object, and the other vehicle B may be referred to as a second moving object.

As shown in FIG. 1, there exists an obstacle (person) in a travel direction of the user's vehicle A. Here, explanation will be made on the assumption that the obstacle is a person. However, the obstacle is not limited to a person, but is any object that can hinder the user's vehicle from traveling, such as an abandoned object on a road, a stopped vehicle or a traveling vehicle.

The user's vehicle A and the other vehicle B are mounted with an on-vehicle radar such as a millimeter-wave radar or a laser radar as a detection device to detect an obstacle. Here, however, it is assumed that a far distance between the user's vehicle A and the obstacle does not allow the user's vehicle A to detect the obstacle with the on-vehicle radar.

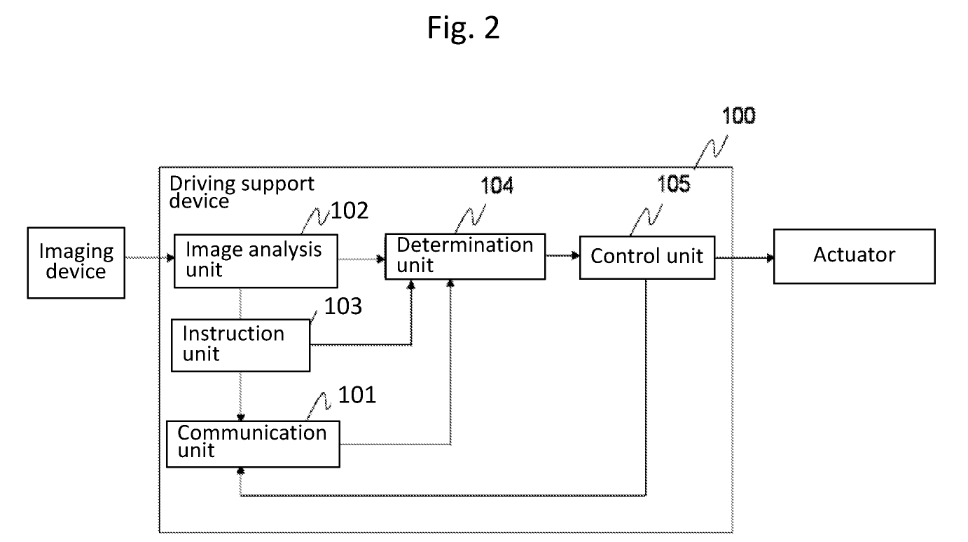

FIG. 2 is a diagram which shows an example configuration of the driving support device 100 according to Embodiment 1. The driving support device 100 includes a communication unit 101, an image analysis unit 102, an instruction unit 103, a determination unit 104, and a controller 105. Explanation will be made below, taking an example of the driving support device 100 mounted on the other vehicle B shown in FIG. 1.

The communication unit 101 controls communication with the user's vehicle A or an external device such as a server. The communication unit 101 receives a position information signal transmitted from the user's vehicle A. The position information signal includes at least position information (latitude, longitude) of the user's vehicle A.

The image analysis unit 102 analyzes an image signal received from an imaging device such as an infrared camera, and acquires the position information of the obstacle. The image signal, for example, is an infrared image signal.

On the basis of a preset condition, the instruction unit 103 instructs: the communication unit 101 to acquire the position information of the user's vehicle A; the image analysis unit 102 to acquire the position information of the obstacle; and the determination unit 104 to start a determination processing, which will be explained later. An example of the condition is defined as whether or not the other vehicle B is positioned within a predetermined range from an intersection (for example, within 100 meters from the intersection) on the basis of the map information and the position information from the other vehicle B. The instruction unit 103 may acquire the map information from a navigation device, for example. If the vehicle support device has an internal map information storage to store map information, the map information may be acquired therefrom. The instruction unit 103 receives the position information signal using GPS (Global Positioning System), which includes the position information (latitude, longitude) of the other vehicle B.

When instructed by the instruction unit 103 to execute the determination processing, the determination unit 104 acquires the position information of the obstacle from the image analysis unit 102 and acquires the position information of the user's vehicle A via the communication unit 101, to determine, on the basis of the both position information, whether or not the user's vehicle A detects the obstacle. The determination unit 104 notifies the controller 105 of the determination result.

When the determination unit 104 determines that the user's vehicle A does not detect the obstacle, the controller 105 performs control so as to inform the user's vehicle A of the existence of the obstacle.

For example, the controller 105 transmits a light control signal to an external actuator. Receiving the light control signal, the actuator controls head lights to change their irradiation direction and/or irradiation amount, etc. of the lights. This is how the controller 105 informs the user's vehicle A of an obstacle.

The controller 105 may transmit a warning signal to the user's vehicle A via the communication unit 101 to inform the user's vehicle A of the existence of the obstacle. The warning signal may be transmitted to the user's vehicle A via a server. Here, the term “information to inform of the existence of an obstacle” is the position information of the obstacle, to which information such as type of the obstacle may further be added.

Next, a hardware configuration of the driving support device 100 will be explained.

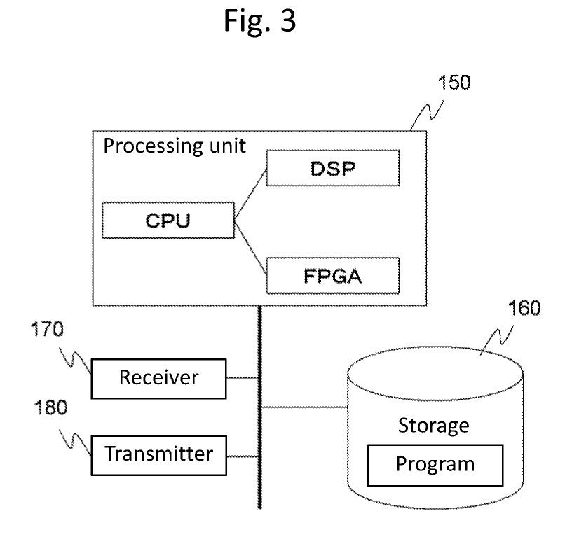

FIG. 3 is a diagram which shows an example of a hardware configuration of the driving support device 100 according to Embodiment 1. The driving support device 100 has a configuration in which a processing unit 150, a storage 160 such as ROM (Read Only Memory) or hard disk, a receiver 170, and a transmitter 180 are connected by a bus. The processing unit 150 consists of at least one or combination of CPU (Central Processing Unit), DSP (Digital Signal Processor), and FPGA (Field Programmable Gate Array). In addition, each of CPU, DSP and FPGA has an internal temporary memory.

Each of the image analysis unit 102, the instruction unit 103, the determination unit 104 and the controller 105 is a program and is stored in the storage 160. The processing unit 150 reads and executes the programs accordingly, to realize their functions. Namely, combinations of the processing unit 150 as hardware with the above-described programs as software realize the functions of the units shown in FIG. 1. In other words, the processing unit 150 is programmed so as to realize each function of the units shown in FIG. 1. Instead of combining hardware and software, these programs may be implemented to the processing unit 150 in order to realize the functions by hardware alone. As understood from above, in order to realize the individual functions, it can be freely designed to operate each of the CPU, the DSP and the FPGA which compose the processing unit 150. However, in view of processing speed, it is desirable for example to allocate image analysis processing of the image analysis unit 102 mainly to the DSP or the FPGA, and to allocate processing of the instruction unit 103, the determination unit 104 and the controller 105 mainly to the CPU.

The communication unit 101 is realized by a receiver 170 and a transmitter 280, or by a transmitter-receiver which is an integration of a transmitter and a receiver.

Next, explanation will be made about the operation of obstacle warning processing according to Embodiment 1.

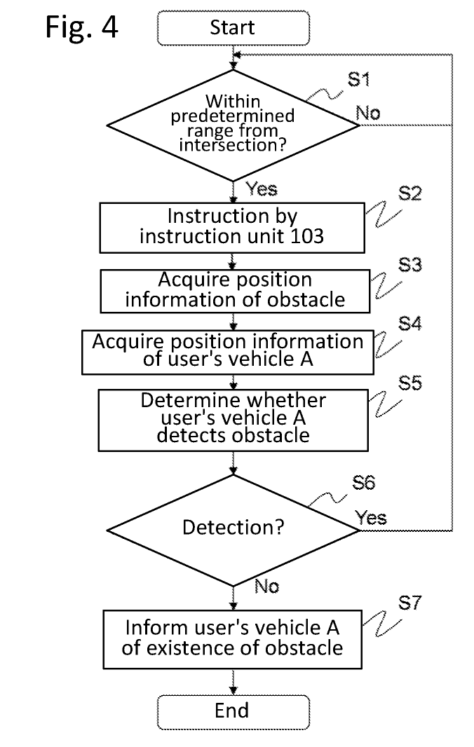

FIG. 4 is a flowchart which shows an example of operation of the obstacle warning processing according to Embodiment 1. Firstly, the instruction unit 103 determines whether or not the other vehicle B is positioned within a predetermined range from an intersection on the basis of the map information and the position information of the other vehicle B (step S1). When it is determined that the other vehicle B is positioned within the predetermined range from the intersection (step S1-Yes), the instruction unit instructs the communication unit 101 to acquire the position information of the user's vehicle A, instructs the image analysis unit 102 to acquire the position information of the obstacle and instructs the determination unit 104 to execute the determination processing (step S2).

Upon receiving the instruction, the image analysis unit 102 analyses the image signal to acquire the position information of the obstacle (step S3). The image analysis unit 102 can calculate the position information of the obstacle by a distance measurement technique using a monocular camera mounted in the front of the vehicle. To be more specific, the image analysis unit 102 receives a captured image corresponding to an image in front of the vehicle, and detects an obstacle in the captured image by performing processing such as processing to extract features defining a contour, and template matching processing. The image analysis unit 102 acquires the position information of the obstacle by calculating the position and the size of the obstacle in the captured image and then obtaining the distance from the other vehicle B to the obstacle.

Upon receiving the instruction, the communication unit 101 acquires position information signal containing the position information of the user's vehicle A through vehicle-to-vehicle communication with the user's vehicle A (step S4). The communication unit 101 may receive the position information signal via the server.

Upon receiving the instruction, the determination unit 104 determines, on the basis of the position information of the user's vehicle A and the position information of the obstacle, whether or not the user's vehicle A detects the obstacle (step S5).

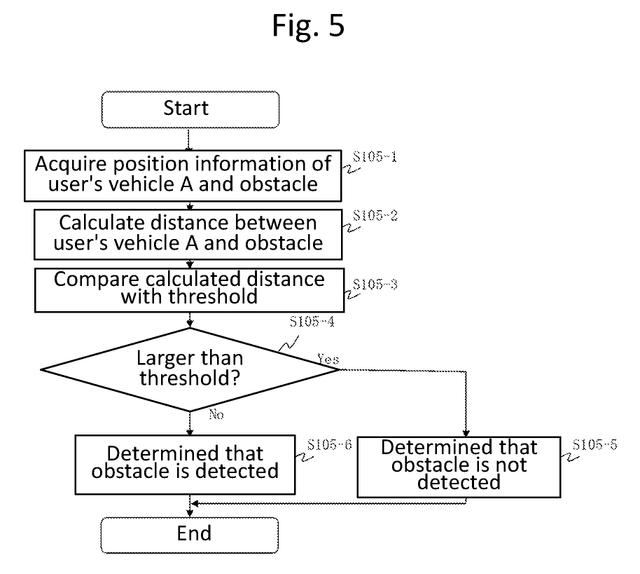

FIG. 5 is a flowchart which shows an example algorithm of the determination processing according to Embodiment 1. The processing unit 150 is programmed so as to realize the determination processing of step S5, whose algorithm is shown in FIG. 5 (step S105-1 through step S105-6) and is performed by the determination unit 104.

Firstly, the determination unit 104 acquires the position information of the user's vehicle A and the position information of the obstacle (step S105-1). Here, let the position information of the user's vehicle A be coordinates (x1, y1) and the position information of the obstacle be coordinates (x2, y2).

Next, the determination unit 104 calculates the distance between the user's vehicle A and the obstacle (step S105-2). Here, the distance d between the user's vehicle A and the obstacle is represented by the following equation (1). In a case where the obstacle is an iron bridge or a blocking bar of a railroad crossing whose height may hinder the passage, the z axis direction may be included in calculating the distance.

[Equation 1]

d=\sqrt{(x₂−x₁)²+(y₂−y₁)²} (1)

Next, the determination unit 104 compares the calculated distance with a predetermined threshold (step S105-3). The threshold can be arbitrarily preset on the basis of detection range information of generally used on-vehicle radars or the like. For example, the detection range of a millimeter-wave radar is 200 to 300 meters; which of a laser is approximately 200 meters; and which of an infrared camera is approximately 30 meters. The threshold may be preset on the basis of these data.

When the calculated distance is equal to or larger than the threshold (step S105-4-Yes), the determination unit 104 determines that the obstacle is out of the detection range of the on-vehicle radar, etc. of the user's vehicle A, and that the user's vehicle A does not detect the obstacle (step S105-5).

When the calculated distance is smaller than the threshold (step S105-4-No), the determination unit 104 determines that the obstacle is within the detection range of the on-vehicle radar, etc. of the user's vehicle A, and that the user's vehicle A detects the obstacle (step S105-6).

Again in FIG. 4, when determining that the user's vehicle A does not detect the obstacle (step S5-No), the determination unit 104 notifies the controller 105 of the determination result. Upon being notified, the controller 105 informs the user's vehicle A of the existence of the obstacle (step S6).

When the determination unit 104 determines that the user's vehicle A detects the obstacle (step S5-Yes), the process returns to step S1.

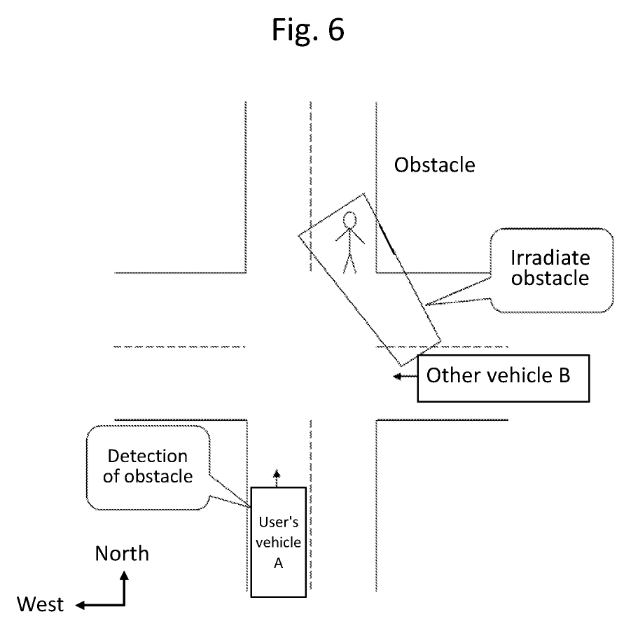

FIG. 6 is a drawing showing an example of the operation of the other vehicle B according to Embodiment 1, in which the other vehicle B informs the user's vehicle A of the existence of an obstacle. The controller 105 of the other vehicle B transmits a light control signal to its actuator to control the light to irradiate the obstacle in order to inform the user's vehicle A of the existence of the obstacle.

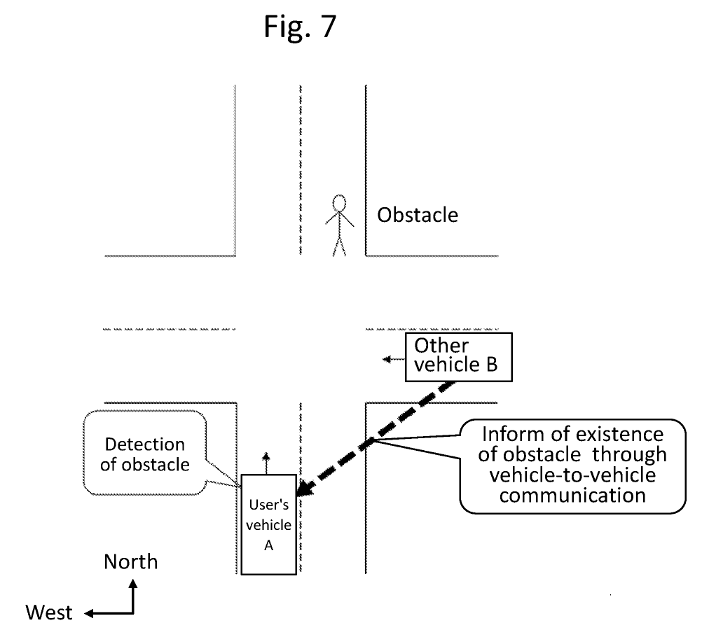

FIG. 7 is a drawing showing another example of operation of the other vehicle B according to Embodiment 1, in which the other vehicle B informs the user's vehicle A of the existence of the obstacle. The controller 105 of the other vehicle B transmits a warning signal to the user's vehicle A through vehicle-to-vehicle communication via its communication unit 101 to inform the user's vehicle A of the existence of the obstacle. The content of the warning information may include type, etc. of the obstacle in addition to the position information. The other vehicle B may inform the user's vehicle A of the existence of the obstacle via a server.

As explained above, according to Embodiment 1, when the determination unit 104 of the vehicle support device 100 determines, on the basis of the position information of the user's vehicle A and the obstacle, that the user's vehicle A does not detect an obstacle, the controller 105 of the vehicle support device 100 informs the user's vehicle A of the existence of the obstacle. Therefore, the driver of the user's vehicle A can perceive in advance the existence of the obstacle which otherwise cannot be detected due to its distant position, and this enables the driver to drive safe.

It has been explained so far that the instruction unit 103 instructs the determination unit 104 to start the determination processing when the instruction unit 103 determines that the other vehicle B is positioned within a predetermined range from an intersection. The way to start the determination processing, however, is not limited to this. For example, another way to start the determination processing is that: the instruction unit 103 obtains the time (collision time) taken by the user's vehicle A to come into collision with the obstacle, from the speed information of the user's vehicle A and the distance between the user's vehicle A and the obstacle calculated from the position information of the obstacle and the position information the user's vehicle A; and when the collision time becomes smaller than a predetermined time, the instruction unit 103 instructs the determination unit 104 to start the determination processing. In this case, the instruction unit 103 acquires the position information of the other vehicle B via the communication unit 101 and the position information of the obstacle from the image analysis unit 102. If the communication unit 101 receives a position information signal from the user's vehicle A which contains the speed information of the user's vehicle A, the instruction unit 103 can be informed of the speed information of the user's vehicle A. If the other vehicle B is equipped with a speed detection sensor, the speed of the user's vehicle A may be detected using the speed detection sensor, and the resulting information may be transmitted to the communication unit 101.

The instruction unit 103 may provide, on the basis of the position information of the user's vehicle A, an instruction to execute the determination processing when an obstacle is positioned in a vicinity within X meters from the user's vehicle A. As for “the vicinity within X meters”, X may be arbitrarily set on the basis of the detection ranges of generally-used on-vehicle radars. Here, the term “vicinity” means the inside of a circle; the center of which is the position of the user's vehicle A; the radius of which is a predetermined distance from the user's vehicle A. Instead of using a circle, an ellipse may be used. By predicting the travel direction of the vehicle, only the forward of the vehicle may be considered as “vicinity”.

So far, it is explained that the position information of an obstacle is acquired by the image analysis unit 102. However, the source of the position information is not limited to this. If the obstacle is a person carrying mobile terminal equipped with GPS function, the communication unit 101 can receive the position information of the obstacle from the mobile terminal.

So far, it is explained that the position information of the user's vehicle A is contained in the position information signal and received by the communication unit 101. However, the source of the position information is not limited to this. For example, when the user's vehicle A and the obstacle exist in a captured image, the image analysis unit 102 can acquire the position information of the user's vehicle A and the obstacle from respective positions and sizes in the captured image.

### Embodiment 2

Embodiment 2 of the present invention will be explained below using drawings. In Embodiment 2, a server 200 determines, on the basis of the position information of a user's vehicle A and the position information of an obstacle, whether or not the user's vehicle A detects the obstacle. When the server 200 determines that the user's vehicle A does not detect the obstacle, the server 200 informs the user's vehicle A of the existence of the obstacle.

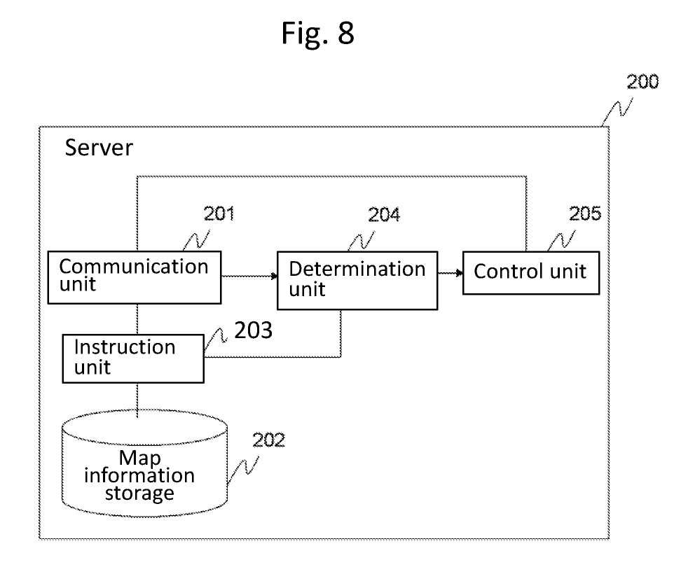

FIG. 8 is a diagram which shows an example of the server configuration according to Embodiment 2. The server 200 of Embodiment 2 includes a communication unit 201, a map information storage 202, an instruction unit 203, a determination unit 204, and a controller 205.

The communication unit 201 controls communication with external devices and periodically receives position information signals from the user's vehicle A and the other vehicle B. The position information signal from the user's vehicle A contains position information of the user's vehicle A. The position information signal from the other vehicle B contains position information of the other vehicle B. In response to the instruction from the instruction unit 203, the communication unit 201 receives, from the other vehicle B, the position information signal which contains the position information of the obstacle.

The map information is stored in the map information storage 202.

The instruction unit 203 instructs the communication unit 201 to acquire the position information of the obstacle on the basis of a predetermined condition, and instructs the determination unit 204 to execute the determination processing. The condition is the same as explained in Embodiment 1. For example, the condition to instruct to execute the determination processing may be that the other vehicle B is positioned within a predetermined range from an intersection or may be that the time (collision time) which the user's vehicle A takes to come into collision with the obstacle becomes smaller than a predetermined time. The instruction to execute the determination processing may be provided when the obstacle is positioned in a vicinity within X meters from the user's vehicle A.

Upon receiving the instruction from the instruction unit 203 to execute the determination processing, the determination unit 204 determines whether or not the user's vehicle A detects the obstacle on the basis of the position information of the user's vehicle A and the obstacle, acquired via the communication unit 201. The determination unit 204 notifies the controller 205 of a determination result.

When the determination unit 204 determines that the user's vehicle A does not detect the obstacle, the controller 205 performs control so as to inform the user's vehicle A of the existence of the obstacle.

For example, the controller 205 transmits a light control signal to control light to a vehicle support device of the other vehicle B via the communication unit 201. The vehicle support device of the other vehicle B, on the basis of the received light control signal, controls the actuator to adjust the direction and the amount of irradiation, etc. of the light. This is how the controller 205 informs the user's vehicle A of the existence of the obstacle.

The controller 205 may transmit the warning signal of the existence of the obstacle to the user's vehicle A via the communication unit 201.

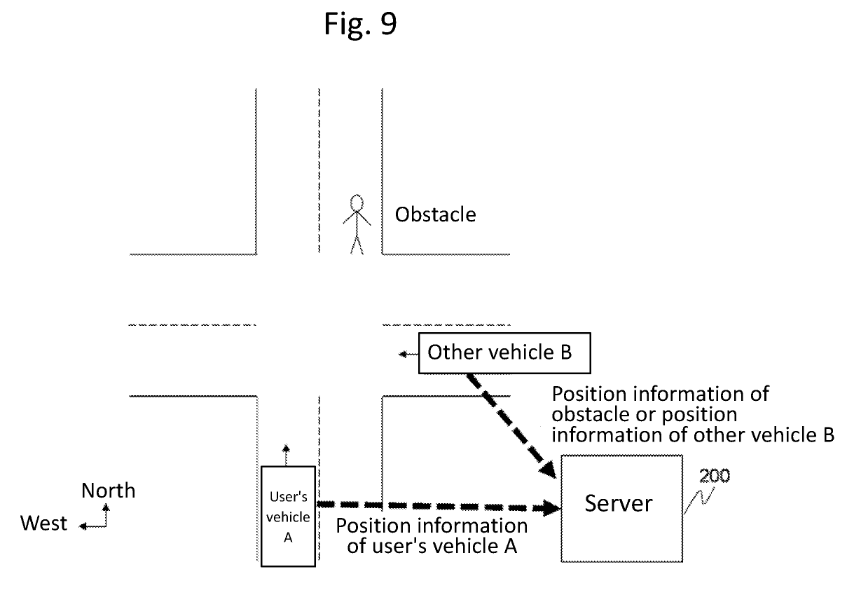

FIG. 9 is a drawing which shows information exchange between the devices according to Embodiment 2. As shown in FIG. 9, the server 200 receives, from the user's vehicle A, a position information signal containing the position information of the user's vehicle A and receives, from the other vehicle B, a position information signal containing at least either the position information of the other vehicle B or the position information of the obstacle. As explained in Embodiment 1, the other vehicle B can acquire the position information of the obstacle through image analysis. When an obstacle is a person carrying a mobile terminal equipped with GPS function, the server 200 may receive the position information signal which contains the position information of the obstacle from the mobile terminal.

Next, a hardware configuration of the server 200 will be explained. As with the hardware configuration of the vehicle support device 100 explained in FIG. 3, the server 200 has a configuration in which a processing unit 150, a storage 160, a receiver 170 and a transmitter 180 are connected by a bus.

Each of the instruction unit 203, the determination unit 204 and the controller 205 is a program and stored in the storage 160. The processing unit 150 reads and executes the programs accordingly, to realize their functions. In order to realize the individual functions, it can be freely designed to operate each of the CPU, the DSP and the FPGA which compose the processing unit 150. However, in view of processing speed, it is desirable for example to allocate image analysis processing of the image analysis unit 102 mainly to the DSP or the FPGA, and to allocate processing of the instruction unit 203, the determination unit 204 and the controller 205 mainly to the CPU. The map information is also stored in the storage 160.

The communication unit 201 is realized by the receiver 170 and the transmitter 280, or by a transmitter-receiver, which is an integration of a transmitter and a receiver.

Next, the operation of obstacle warning processing according to Embodiment 2 will be explained.

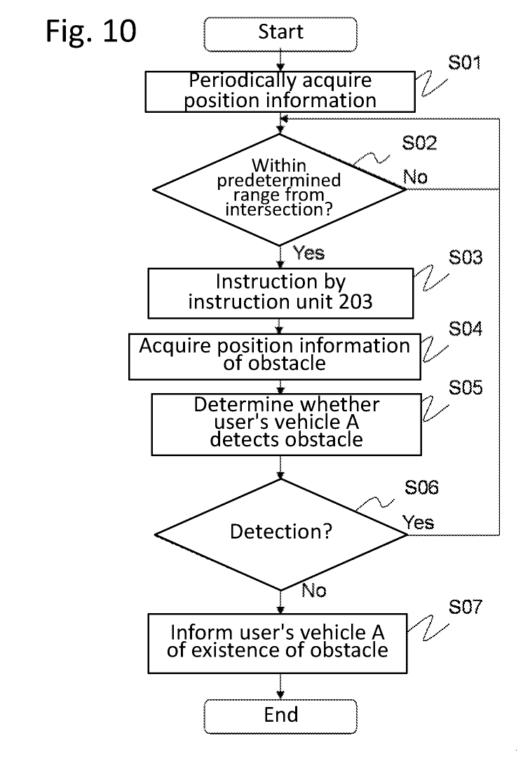

FIG. 10 is a flowchart which shows an example of the obstacle warning processing according to Embodiment 2. The communication unit 201 of the server 200 periodically receives a position information signal from the user's vehicle A and a position information signal from the other vehicle B to periodically acquire the position information of the user's vehicle A and the position information of the other vehicle B (step S01).

The instruction unit 203 determines whether or not the other vehicle B is positioned within a predetermined range from an intersection on the basis of the position information of the other vehicle B acquired via the communication unit 201 and map information stored in the map information storage 202 (step S02).

When the instruction unit 203 determines that the other vehicle B is positioned within a predetermined range from the intersection (step S02-Yes), the instruction unit 203 instructs the communication unit 201 to acquire the position information of the obstacle (step S03). At this point, the instruction unit 203 may instruct the communication unit 201 to once again acquire the position information of the user's vehicle A and the position information of the other vehicle B. The instruction unit 203 instructs the determination unit 204 to execute the determination processing.

Upon receiving the instruction, the communication unit 201 performs vehicle-to-vehicle communication with the other vehicle B to receive from the other vehicle B a position information signal containing the position information of the obstacle, and transmits the position information of the other vehicle B to the determination unit 204 (step S04).

When receiving from the instruction unit 203 an instruction to execute the determination processing, the determination unit 204 determines whether or not the user's vehicle A detects the obstacle on the basis of the position information of the user's vehicle A and the position information of the obstacle acquired via the communication unit 201 (step S05).

When the determination unit 204 determines that the user's vehicle A detects the obstacle (step S06-Yes), the process returns to the processing of step S02.

When the determination unit 204 determines that the user's vehicle A does not detect the obstacle (step S06-No), the controller 205 informs the user's vehicle A of the existence of the obstacle (step S07).

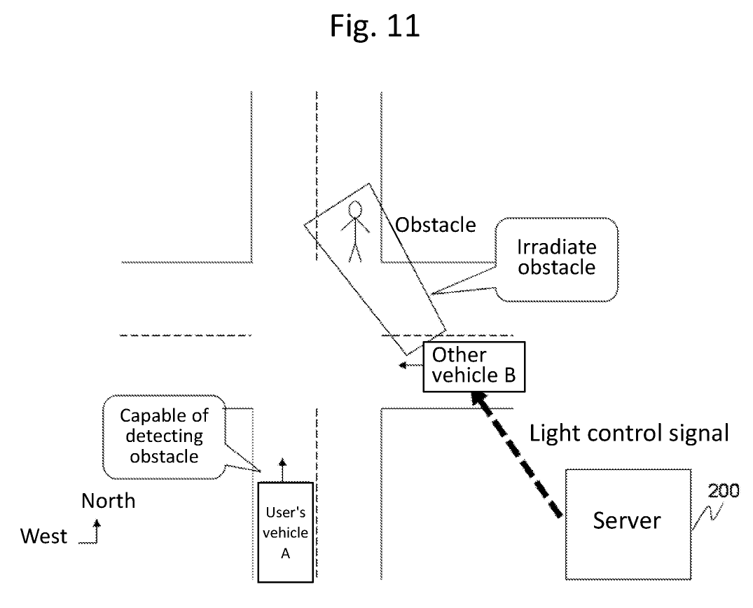

FIG. 11 is a drawing which shows an example of operation of the server 200 according to Embodiment 2 to inform the user's vehicle A of the existence of the obstacle. The controller 205 of the server 200 transmits a light control signal to the other vehicle B. Receiving the light control signal, the other vehicle B controls the own light to irradiate the obstacle in order to inform the user's vehicle A of the existence of the obstacle.

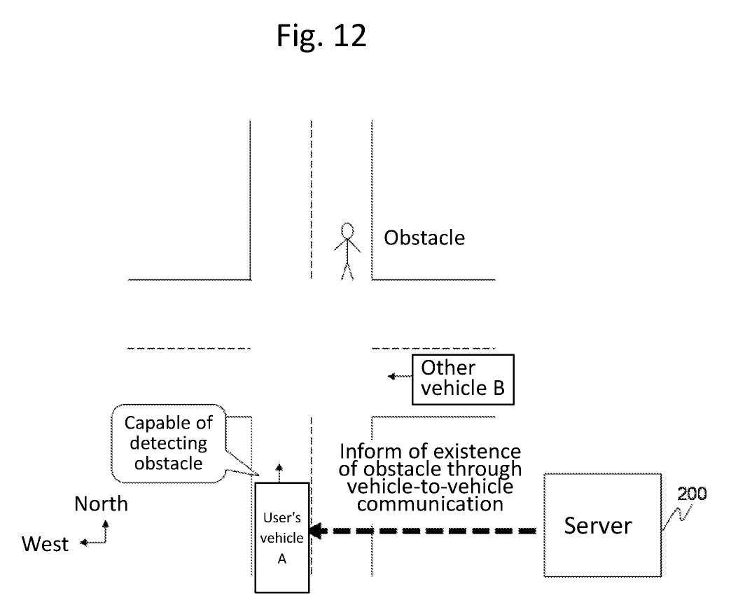

FIG. 12 is a drawing which shows another example of operation of the server 200 according to Embodiment 2 to inform the user's vehicle A of the existence of the obstacle. The controller 205 of the server 200 transmits a warning signal via the communication unit 201 and informs the user's vehicle A of the existence of the obstacle through vehicle-to-vehicle communication with the user's vehicle A. The content of the warning information may include the obstacle type, etc. in addition to the position information of the obstacle.

As explained above, according to Embodiment 2, when the determination unit 204 of the server 200 determines that user's vehicle A does not detect an obstacle on the basis of the position information of the user's vehicle A and the obstacle, the controller 205 of the server 200 informs the user's vehicle A of the existence of the obstacle. Therefore, the driver of the user's vehicle A can perceive in advance the existence of the obstacle which otherwise cannot be detected due to its distant position, this enables the driver to drive safe.

### Embodiment 3

Embodiment 3 of the present invention will be explained below using the drawings. Embodiment 3 differs from Embodiment 2 in that the server 200 utilizes information on detection performance of the detection devices such as an on-vehicle radar, for determining whether or not the user's vehicle A detects an obstacle.

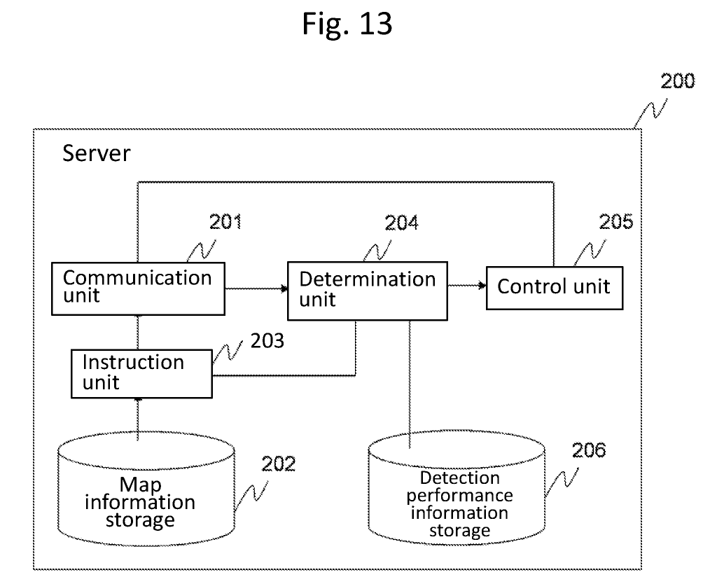

FIG. 13 is a diagram which shows an example of a server configuration according to Embodiment 3. The server 200 in Embodiment 3 includes a communication unit 201, a map information storage 202, an instruction unit 203, a determination unit 204, a controller 205 and a detection performance information storage 206. The communication unit 201, the map information storage 202, the instruction unit 203 and the controller 205 are the same as explained in Embodiment 1. Therefore, the same symbols are assigned as in FIG. 8, and their explanation will be omitted.

In the detection performance information storage 206, the detection performance information is stored, in which information on detection performance of an on-vehicle radar mounted to each vehicle is linked with the identification information (vehicle ID) of the vehicle.

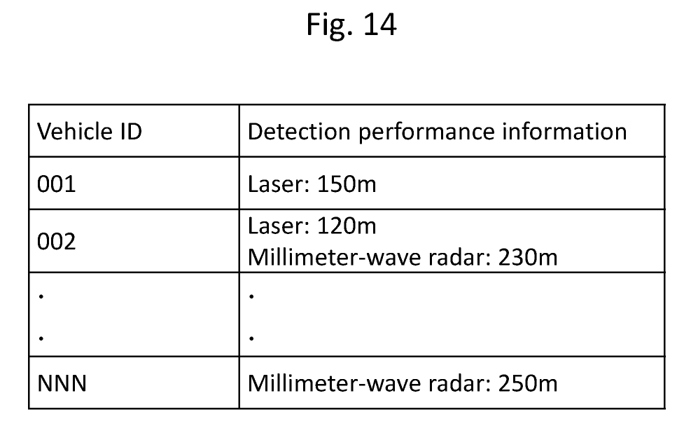

FIG. 14 is a table which shows an example of the detection performance information according to Embodiment 3. As illustrated in FIG. 14, the vehicle IDs and respective detection performance of the on-vehicle radars mounted to the vehicles are linked to each other and stored. In addition, the vehicle IDs are not limited to individual information of the respective vehicles; information about the types of the vehicles, for example, may be used for the identification.

The server 200 stores the detection performance information collected in advance on each vehicle in the detection performance information storage 206.

Next, the operation of obstacle warning processing according to Embodiment 3 will be explained.

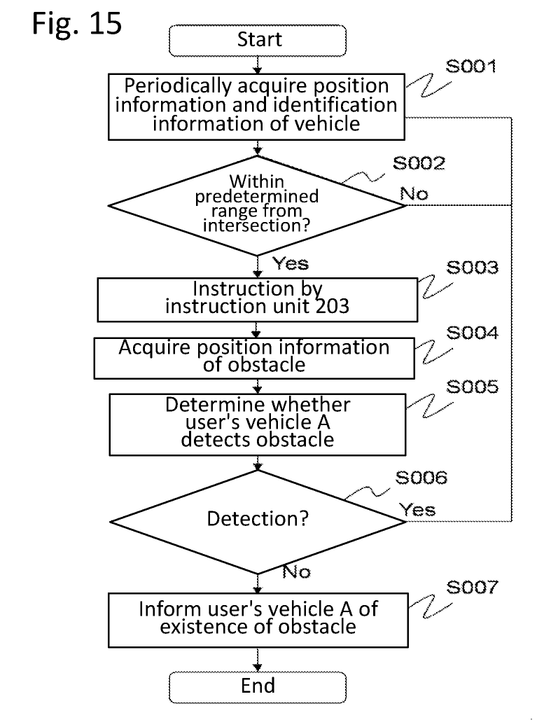

FIG. 15 is a flowchart of an example of the obstacle warning processing according to Embodiment 3. The processing of steps S002, S003, S004, S006 and S007 is the same as that of the steps S02, S03, S04, S06 and S07 respectively, explained in FIG. 10 of Embodiment 2. Therefore, their explanation will be omitted.

The communication unit 201 of the server 200 periodically receives a position information signal from the user's vehicle A and a position information signal from the other vehicle B to periodically acquire the position information of the user's vehicle A and the position information of the other vehicle B. At this point, the vehicle identification information is contained in the position information signal from each vehicle (step S001).

Next, in step S005, the determination unit 204 determines whether or not the user's vehicle A detects the obstacle on the basis of the position information of the user's vehicle A, the position information of the obstacle, and further the detection performance information stored in the detection performance information storage 206.

For example, let the vehicle ID of the user's vehicle A be “001”. The determination unit 204 firstly calculates the distance between the user's vehicle A and the obstacle from the position information of the user's vehicle A and the position information of the obstacle. Here, the distance between the user's vehicle A and the obstacle is supposed to be 200 m. Then, the determination unit 204 determines whether or not the calculated distance is within the detection range of the on-vehicle radar mounted to the user's vehicle A. As shown in FIG. 13, because the detection performance of the on-vehicle laser radar with the vehicle ID “001” is 150 m, the determination unit 204 determines that the user's vehicle A does not detect the obstacle.

As explained above, according to Embodiment 3, the server 200 includes the detection performance information storage 206 in which the detection performance information on on-vehicle radars is stored, and the determination unit 204 determines whether or not the user's vehicle A detects an obstacle on the basis of the position information of the user's vehicle A, the position information of the obstacle, and the detection performance information on the on-vehicle radar mounted to the user's vehicle A. Therefore, the accuracy in determining whether or not the user's vehicle A detects an obstacle can be improved, which leads to more accurate warnings for drivers against obstacles.

In addition, the so far explained vehicle support device 100 itself may be referred to as a vehicle support system. Similarly, the server 200 itself may be referred to as a vehicle support system. Also, a system including the vehicle support device 100 and the server 200, namely a system including multiple devices, may be referred to as a vehicle support system. When a vehicle support system includes a vehicle support device 100 and a server 200, the multiple functions may be allotted between them. For example, if the vehicle support device 100 shown in FIG. 2 performs the processings of the communication unit 101, the image analysis unit 102, and the instruction unit 103, and the server 200 performs the processings of the determination unit 104 and the controller 105, the processing load of the vehicle support device 100 can be reduced.

### DESCRIPTION OF SYMBOLS

100: vehicle support device
101: communication unit
102: image analysis unit
103: instruction unit
104: determination unit
105: controller
150: processing unit
160: storage
170: receiver
180: transmitter
200: server
201: communication unit
202: map information storage
203: instruction unit
204: determination unit
205: controller
206: detection performance information storage

1-9. (canceled)

10. A driving support system comprising
a controller that is provided outside a first moving object to inform the first moving object of existence of an obstacle with which the first moving object is to collide within a predetermined time.

11. The driving support system according to claim 10, wherein the controller informs the first moving object of the existence of an obstacle with which the first moving object is to collide within a predetermined time, when the distance between the first moving object and the obstacle is equal to or larger than a predetermined distance.

12. The driving support system according to claim 10, further comprising a determination unit to determine whether or not the first moving object detects the obstacle on the basis of position information of the first moving object and position information of the obstacle, wherein the controller informs the first moving object of the existence of the obstacle when the determination unit determines that the first moving object does not detect the obstacle.

13. The driving support system according to claim 11, further comprising a determination unit to determine whether or not the first moving object detects the obstacle on the basis of position information of the first moving object and position information of the obstacle, wherein the controller informs the first moving object of the existence of the obstacle when the determination unit determines that the first moving object does not detect the obstacle.

14. The driving support system according to claim 12, wherein the determination unit determines that the first moving object does not detect the obstacle when the distance between the first moving object and the obstacle is larger than a predetermined threshold.

15. The driving support system according to claim 12, wherein the determination unit determines, on the basis of performance information of a detection device for the first moving object to detect an obstacle, that the first moving object does not detect the obstacle.

16. The driving support system according to claim 10, wherein the controller informs the first moving object of the existence of the obstacle by transmitting a warning signal including the position information of the obstacle to the first moving object.

17. The driving support system according to claim 11, wherein the controller informs the first moving object of the existence of the obstacle by transmitting a warning signal including the position information of the obstacle to the first moving object.

18. The driving support system according to claim 12, wherein the controller informs the first moving object of the existence of the obstacle by transmitting a warning signal including the position information of the obstacle to the first moving object.

19. The driving support system according to claim 10, wherein the controller informs the first moving object of the existence of the obstacle by transmitting a light control signal, for controlling light to irradiate the obstacle, to a second moving object other than the first moving object.

20. The driving support system according to claim 11, wherein the controller informs the first moving object of the existence of the obstacle by transmitting a light control signal, for controlling light to irradiate the obstacle, to a second moving object other than the first moving object.

21. The driving support system according to claim 12, wherein the controller informs the first moving object of the existence of the obstacle by transmitting a light control signal, for controlling light to irradiate the obstacle, to a second moving object other than the first moving object.

22. The driving support system according to claim 10, wherein the controller is included in a driving support device mounted to a second moving object other than the first moving object.

23. The driving support system according to claim 11, wherein the controller is included in a driving support device mounted to a second moving object other than the first moving object.

24. The driving support system according to claim 12, wherein the controller is included in a driving support device mounted to a second moving object other than the first moving object.

25. The driving support system according to claim 16, wherein the controller is included in a driving support device mounted to a second moving object other than the first moving object.

26. The driving support system according to claim 10, wherein the controller is included in a server.

27. The driving support system according to claim 11, wherein the controller is included in a server.

28. A driving support method comprising a step in which a device provided outside a first moving object informs the first moving object of the existence of an obstacle with which the first moving object is to collide within a predetermined time.

29. A program to make a computer provided outside a first moving object execute control processing to inform the first moving object of the existence of an obstacle with which the first moving object is to collide within a predetermined time.
